(19) United States
(12) Patent Application Publication
(10) Pub. No.: US 2026/0228004 A1
(43) Pub. Date: Aug. 6, 2026

(54) SELECTIVE THROTTLING BASED ON DATATYPE

(71) Applicant: XILINX, INC., San Jose, CA (US)

(72) Inventors: Juan J. NOGUERA SERRA, San Jose, CA (US); Alejandro RICO CARRO, Austin, TX (US); David Patrick CLARKE, Dublin (IE); Francisco BARAT QUESADA, Erembodegem (BE)

(21) Appl. No.: 19/043,290

(22) Filed: Jan. 31, 2025

(51) Int. Cl. G06F 9/30; G06F 9/38

(52) U.S. Cl. CPC G06F 9/3005; G06F 9/3861

(57) ABSTRACT

Embodiments describe throttling cores in an IC based on the datatype. Government regulations or export control may indicate the maximum number of operations that can be performed in the IC. However, the IC may perform operations at different rates. For example, the maximum number of operations that an IC can perform in a given time period can be different depending on the datatypes—e.g., 200 Tera Operations per Second (TOPS) for INT4 datatypes but only 100 TOPS for INT8 datatypes. Embodiments herein perform throttling based on particular datatypes so the IC is not unnecessarily throttled.

### TECHNICAL FIELD

Examples of the present disclosure generally relate to throttling a core in a processor or accelerator according to datatype.

### BACKGROUND

Integrated circuits (ICs) or semiconductor chips are sometimes subject to policies or regulations that limit a rate at which the ICs can perform certain types of operations. For example, government export controls or requirements can provide a maximum rate operations can be performed in an IC when sold in certain foreign jurisdictions. These controls may stipulate, for example, the maximum operations that can be performed in a certain area of an IC during a certain time period. A chip manufacturer must ensure their ICs are unable to exceed the maximum operational rate.

### SUMMARY

One embodiment described herein is an IC that includes a fuse that sets a maximum operational rate for the IC, a core configured to execute an instruction, and throttling logic. The throttling logic include circuitry configured to receive from the core a signal indicating a datatype used when performing the instruction, and, in response to determining that the core exceeds the maximum operational rate based on the datatype, insert at least one stall cycle into the core to make the IC compliant with the maximum operational rate.

One embodiment described herein is a method that includes receiving, from a core at throttling logic, a signal indicating a datatype used when performing an instruction in the core and, in response to determining that the core exceeds a maximum operational rate based on the datatype, inserting at least one stall cycle into the core to make the IC compliant with the maximum operation rate. Moreover, the maximum operation rate is set by a fuse in an integrated circuit (IC) containing the core.

One embodiment described herein is an IC that includes a fuse that sets a maximum operational rate for the IC where the maximum operational rate is based on a government regulation and a particular geographic region, compute circuitry configured to execute an operation, and throttling logic. The throttling logic includes circuitry configured to receive a signal indicating a datatype used when performing the operation and, in response to determining that the compute circuitry exceeds the maximum operational rate based on the datatype, insert at least one stall cycle into the compute circuitry to make the IC compliant with the maximum operation rate.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates an IC that throttles a core based on a datatype, according to an example.

FIG. 2 illustrates an IC that throttles a core based on a datatype and a counter according to one embodiment.

FIG. 3 illustrates a super scalar processor that throttles different compute circuitry based on the datatype, according to an example.

FIG. 4 is a flowchart for configuring an IC to satisfy export control or regulations, according to one embodiment.

FIG. 5 is a flowchart for throttling cores in an IC to satisfy export control or regulations, according to one embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe throttling cores in an IC based on the datatype. Policies or regulations, such as government regulations or export control, may indicate the maximum number of operations that can be performed in the IC. However, the IC may perform different operations at different rates. For example, the maximum number of operations that an IC can perform in a given time period can be different depending on the datatypes—e.g., 200 Tera Operations per Second (TOPS) for INT4 datatypes but only 100 TOPS for INT8 datatypes. An IC could determine the maximum number of operations it can perform (for any datatype) and then slow down its clock frequency accordingly. For example, if the IC can perform 200 TOPS for INT4, and the government regulations says the maximum rate is 100 TOPS, the IC can slow its clock by half (e.g., by halving the frequency or clock gating every other clock cycle). However, this also slows down the INT8 operations by half (e.g., from 100 TOPS to 50 TOPS), but the INT8 operations satisfied the government regulations (e.g., no more than 100 TOPS) before the clock was slowed. Thus, this approach can unnecessarily slow down certain operations.

Instead, the embodiments herein perform throttling based on particular datatypes, rather than as a whole (or based on the fastest datatype). In one embodiment, the IC includes throttling logic that is informed by a core what type of operation it is (or is about to) perform. Namely, the IC identifies the datatype of the operation. If executing that datatype does not exceed the government regulation (as is the case of an INT8 operation in the example above), the throttling logic does not throttle the core. However, if the datatype does exceed the government regulations (as does the INT4 operation in the example above), the throttling logic does throttle the core (e.g., injects a stall cycle into the core so the rate is reduced by half).

In another embodiment, the throttling logic includes a counter that tracks the different datatype operations performed in a given time period. If the rate derived from the counter indicates the government regulation is exceeded, then no throttling is needed. For example, if in a first time period the core did 75 INT8 operations and 25 INT4 operations with a rate of 100 TOPS, then no throttling is needed. However, if in a second time period (which is the same duration as the first time period) the core did 200 INT4 operations that resulted in a rate of 200 TOPS, then throttling logic may stall the core to bring the overall TOPS down to the 100 TOPS maximum rate established by the government regulations.

Moreover, the government regulations may stipulate the maximum operation rate for each datatype (e.g., a different TOPS for INT4 than INT8). The embodiments herein could also be used to ensure the IC satisfies those regulations.

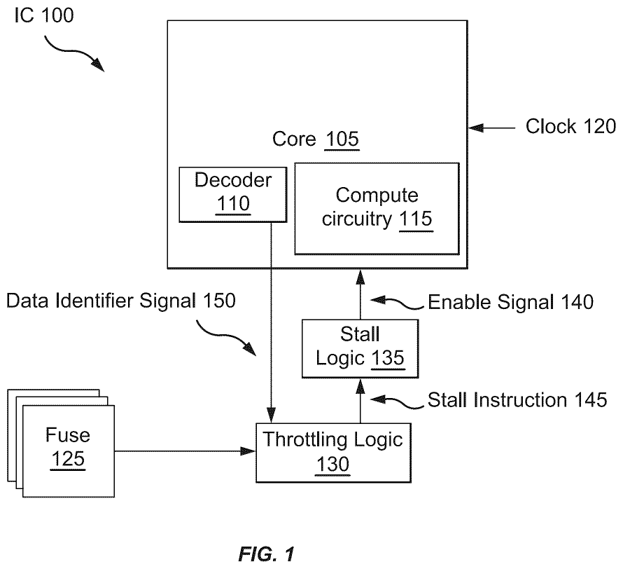

FIG. 1 illustrates an IC 100 that throttles a core 105 based on a datatype, according to an example. The IC 100 can be a processor (e.g., a central processing unit (CPU), an application specific integrated circuit (ASIC), a graphics processing unit (GPU), a data processing unit (DPU), a system on a chip (SoC), or a hardware accelerator (e.g., an artificial intelligence (AI) accelerator)). The IC 100 can be any semiconductor chip that is governed by export controls or regulations to limit its operational speed.

Moreover, the IC 100 can be used to perform any number of tasks. For example, processing limits often arise in ICs with massive parallelism. These ICs often execute artificial intelligence (AI) or machine learning (ML) applications, radio frequency (RF) processing, and the like. In general, the embodiments herein can be used for any application that performs operations using different datatypes.

The IC 100 can include any number of cores 105, although only one core 105 is shown in FIG. 1. The core 105 can include a decoder 110 and compute circuitry 115 (among many other types of circuitry that is not shown). The decoder 110 (e.g., hardware circuitry) can take a computer instruction and translate it into a set of control signals that direct the other components in the core, such as the compute circuitry 115, to execute the instruction. That is, the decoder 110 interprets the instruction and tells the other components in the core 105 how to perform that instruction.

The compute circuitry 115 can the perform the operation corresponding to the instruction. For example, the compute circuitry 115 can include arithmetic logic units (ALUs), multipliers, data processing engines, and the like to perform the operation (or operations) corresponding to a decoded instruction.

As part of its responsibilities, the decoder 110 determines what type of datatype is performed in the instruction. That is, the decoder 110 can determine if the instruction performs an operation using INT4 (4 bit integer values), INT8, INT16, FP4 (4 bit floating point values), FP8, FP16, FP32, BFP (block floating points), and the like.

The core 105 includes a port that communicatively couples the decoder 110 to throttling logic 130. The throttling logic 130 can include hardware, firmware, etc. that receives a data identifier signal 150 from the decoder 110 indicating what type of datatype is (or will shortly be) performed by the core 105. For example, each time the decoder 110 decodes an instruction (and in the process determines the type of data used in that instruction), the decoder 110 can use the data identifier signal 150 to inform the throttling logic 130 of the datatype of the operation being performed.

The throttling logic 130 also receives input from one or more fuses 125 in the IC 100. The fuses 125 contain information indicating the maximum number of operations that the IC 100 can perform in order to satisfy government regulations. In this example, the IC 100 can have multiple fuses 125 which can store immutable data for different regions. For example, a first fuse 125 may have the maximum TOPS that can be performed when the IC is sold in a first geographic region, a second fuse 125 can have the maximum TOPS that can be performed in a second geographic region, and so forth. A manufacturer can then select which fuse 125 to use (and the others can be disabled) depending on where the IC 100 will be sold. The fuse 125 can include any technology that enables permanent information to be stored on the IC 100.

In one embodiment, the fuses 125 can also store the TOPS for particular datatypes (if that is included in the government regulation). For example, one fuse 125 may indicate the maximum TOPs for INT4, a second fuse 125 may indicate the maximum TOPs for INT8, a third fuse 125 may indicate the maximum TOPs for INT16, a fourth fuse 125 may indicate the maximum TOPs for FP4, and so forth.

The throttling logic 130 can use the information in one or more of the fuses 125 and the data identifier signal 150 to throttle the core 105. The throttling logic 130 can include memory (e.g., registers) that indicate the speed at which it can perform certain operations. For example, these registers may indicate the core 105 can perform 200 TOPS when doing INT4 operations but only 100 TOPS when doing INT8 operations. If the data identifier signal 150 indicates the current operation being performed by the decoder 110 is an INT4, and the maximum TOPS indicated in the fuse 125 is 100 TOPS, then the throttling logic 130 can insert a stall cycle into the core 105 using stall logic 135. In this example, the stall logic 135 can use an enable signal 140 to stall the core 105 for one cycle (where the compute circuitry 115 is idle for that cycle). This reduces the effective TOPS of the core 105 when performing INT4 operations from 200 TOPS to 100 TOPS, thereby satisfying the government regulations.

However, if the data identifier signal 150 indicates the operation is an INT8, the throttling logic 130 knows (using its registers) that the core 105 executes INT8 operations at a rate of 100 TOPS, which already satisfies the government regulations in the fuse 125, and thus, no throttling is performed.

In one embodiment, the registers or memory in the throttling logic 130 used to determine whether to throttle the core 105 based on the current datatype being operated on may also be protected memory, such as read only memory or fuses, so a customer cannot change these values. That is, the throttling logic 130 can be protected so a customer cannot change a register corresponding to INT4 datatype to indicate the core 105 can execute these instructions only at a rate of 100 TOPS so the throttling logic 130 will not throttle these instructions.

The throttling logic 130 may insert idle cycles into the core 105 before, after, or during the operation that causes the throttling logic 130 to idle the core 105. For example, after a decoder 110 determines that the instruction is an INT4 operation, it may take several cycles before the compute circuitry 115 is ready to execute the INT4 operation. In the meantime, the throttling logic 130 may have already determined that it should insert one or more stall cycles. The throttling logic 130 could insert the stall cycle before the compute circuitry 115 has begun to perform the INT4 operation (e.g., while the compute circuitry 115 is still performing a different operation). In another embodiment, the throttling logic 130 may insert the stall cycle while the compute circuitry 115 executes the INT4 operation, or the throttling logic 130 may insert the stall cycle after the compute circuitry 115 has already completed the INT4 operation and is now performing a different operation. In any of these cases, the stall cycle reduces the effective operational rate of the IC 100, and thus, causes the IC 100 to satisfy the maximum operational rate indicated in the fuse 125.

Moreover, in some examples, the throttling logic 130 may insert multiple stall cycles for a particular datatype, or may wait to detect several operations using the same datatype before inserting a stall. As an example of the former, if the core can perform 300 TOPS for INT4 operations but the maximum rate is 100 TOPS, the throttling logic 130 may insert two stall cycles for every INT4 operation detected by the decoder 110. As an example of the latter, if the core can perform 150 TOPS for INT4 operations but the maximum rate is 100 TOPS, the throttling logic 130 can wait until the decoder 110 detects two INT4 operations before inserting a stall cycle. That is, for every two INT4 operations performed by the core 105, the throttling logic 130 inserts one stall cycle.

The core 105 can include circuitry that is driven by the enable signal 140 that stalls the core 105 (or just a portion of the core 105). For example, the core 105 can include an AND gate that receives the clock 120 and the enable signal 140 as inputs. If the enable signal 140 goes low (indicating a stall), the output of the AND gate is held low, thereby gating the clock 120. Any circuitry in the core 105 downstream from the AND gate will be idle until the enable signal 140 goes high again (when the stall logic 135 finishes inserting stall cycles). However, using an AND gate is just one suitable way to perform clock gating.

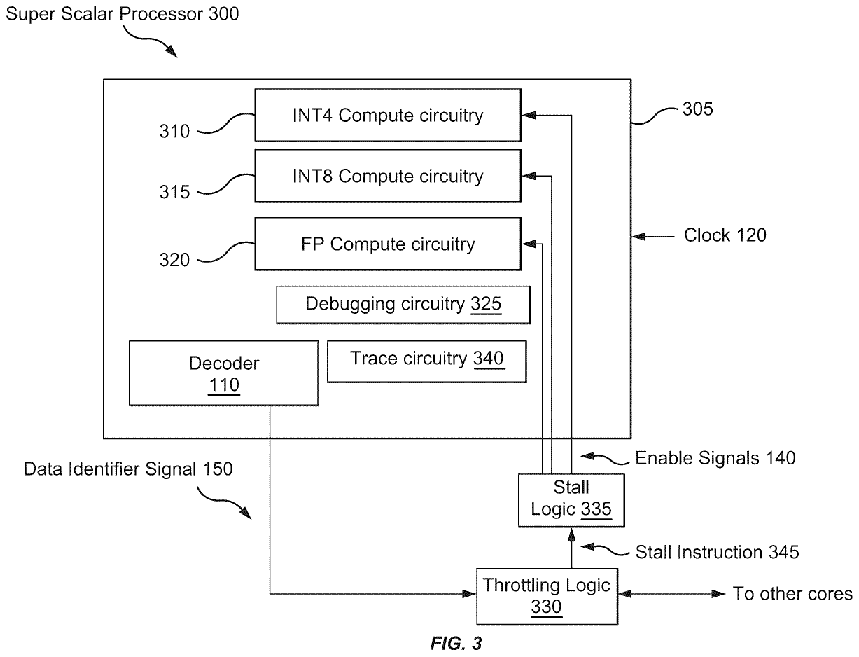

As discussed in more detail in FIG. 3 below, the clock 120 may not be gated or blocked for some circuitry in the core 105. That is, while the enable signal 140 may block the clock 120 from reaching the compute circuitry 115, the clock 120 may not be blocked from being received at other components in the core 105 which can continue to operate using the clock 120.

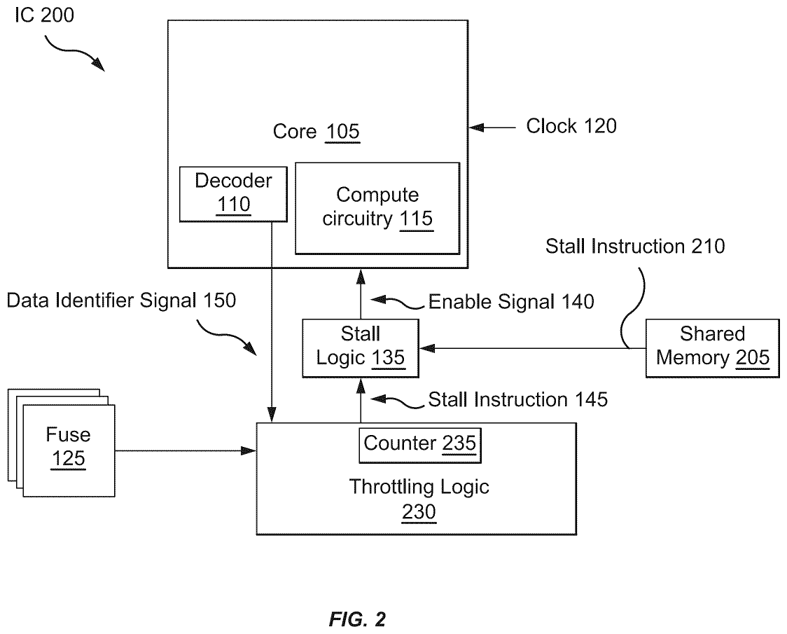

FIG. 2 illustrates an IC 200 that throttles the core 105 based on a datatype and a counter, according to one embodiment. The IC 200 includes many of the same or similar components as discussed in FIG. 1, as indicated by using the same reference numbers.

The IC 200 includes throttling logic 230 which includes a counter 235. In this embodiment, the counter 235 can track the number of operations detected by the decoder 110 over a predefined period of time (e.g., a few milliseconds or micro seconds). During this time period, the decoder 110 can use the data identifier signal 150 to indicate the operations that are performed by the core 105.

The throttling logic 230 can use the information stored in the counter 235 to determine whether to throttle the core 105 in subsequent cycles. That is, after the time period expires, the throttling logic 230 can determine whether the information in the counter 235 indicates the core 105 performed operations that exceeded the maximum rate in the selected fuse 125. As examples, if in a first time period the core did 75 INT8 operations and 25 INT4 operations with a rate of 100 TOPS, then no throttling is needed assuming the maximum rate of operations is 100 TOPS. However, if in a second time period (which is the same duration as the first time period) the core did 100 INT4 operations that resulted in a rate of 200 TOPS, then the throttling logic 230 stalls the core 105 to bring the overall TOPS down to the 100 TOPS maximum rate (e.g., inserts 100 stall cycles).

In this example, the throttling logic 230 may not have to track the specific datatypes in order to throttle the core 105. Instead, the counter 235 can track the number of operations performed by the core in the predefined period of time, regardless of the datatypes. The datatypes will inherently affect the number of operations that can occur during the time period. For example, if executing INT8 operations requires twice as many cycles as executing INT4 operations in the core 105, then a time period where the core 105 executes only INT8 operations will have half as many operations as a time period where the core 105 executes only INT4 operations. The throttling logic 230 can use the total operations performed in the period (based on the information in the counter 235) to determine whether it exceeded the maximum rate in the fuse 125, without having to consider the datatypes used in those operations. Thus, by counting the number of operations for a set period of time, the throttling logic 230 can intelligently throttle the core 105 to adjust for the different types of operations that may be performed during that time period.

The IC 200 also includes shared memory 205, which the core 105 may share with other circuitry in the IC 200 (e.g., another core in the same processor, another processing the IC, other circuitry in the IC 200, and the like). The core 105 may currently be executing an instruction that requires access to the shared memory 205, but may be locked out because the shared memory 205 is currently being used by another component in the IC 200. In response, the shared memory 205 can transmit a stall instruction 210 to the stall logic 135 which instructs the stall logic 135 to idle the core 105 by inserting stall cycles, in the same way the throttling logic 230 can idle the core 105 to ensure the core 105 satisfies the maximum rate in the fuse 125. Once the conflict is resolved, the shared memory 205 can disable the enable signal 140, and the core 105 can begin to execute again and access the shared memory 205 to retrieve (or store) the information it needs in order to complete the current instruction. Thus, FIG. 2 illustrates that the stall logic 135 can be used by different circuitry in the IC 200 to stall the core 105 for different reasons—e.g., to idle the core 105 to satisfy a maximum operation rate or to idle the core 105 when it attempts to access a shared resource that is currently being used by another component in the IC 200.

FIG. 3 illustrates a super scalar processor 300 that throttles different compute circuitry based on the datatype, according to an example. The processor 300 includes many of the same or similar components as discussed in FIG. 1, as indicated by using the same reference numbers.

The super scalar processor 300 includes a core 305 which includes the decoder 110 along with specialized hardware to perform operations using different datatypes—i.e., INT4 compute circuitry 310, INT8 compute circuitry 315, and FP compute circuitry 320. That is, the decoder 110, when decoding an instruction, can select which compute circuitry should execute the corresponding operations based on the datatype—e.g., INT4 operations are assigned to the INT4 compute circuitry 310, INT8 operations are assigned to the INT4 compute circuitry 315, and so forth.

As above, the decoder 110 can receive instructions, determine the datatypes used in the operations for the instruction, and then inform the throttling logic 330 using the data identifier signal 150.

In addition to receiving the signal 150, the throttling logic 330 also receives input from one or more fuses (not shown in this example) in the processor 300. The fuses contain information indicating the maximum number of operations that the processor 300 can perform in order to satisfy government regulations. The throttling logic 330 can use the information in one or more of the fuses and the data identifier signal 150 to throttle the compute circuitry. The throttling logic 330 can include memory (e.g., registers) that indicate the speed at which it can perform certain operations. For example, these registers may indicate the core 305 can perform 200 TOPS when doing INT4 operations but only 100 TOPS when doing INT8 operations. If the data identifier signal 150 indicates the current operation being performed by the decoder 110 is an INT4, and the maximum TOPS indicated in the fuse is 100 TOPS, then the throttling logic 330 can insert a stall cycle into the core 305 using stall logic 335.

However, unlike in FIG. 1 where the stall logic 135 stalls the entire core, here the stall logic 335 may stall only a portion of the compute circuitry in the core 305. When inserting a stall cycle, the throttling logic 330 can inform the stall logic 335 which compute circuitry in the core 305 should be stalled—e.g., the INT4 compute circuitry 310 in this example. As shown, the stall logic 335 can include separate enable signals 350 for individually stalling the different compute circuitry in the core 305. That is, the stall logic 335 can stall the INT4 compute circuitry 310 while the INT8 compute circuitry 315 and the FP compute circuitry 320 can continue to execute. That is, the throttling logic 330 can use the stall logic 335 to stall only the compute circuitry in the core 305 that caused (or will cause) the core 305 to exceed the maximum operation rate while the other compute circuitry in the core 305 is free to continue to execute.

In one embodiment, the enable signals 350 can block or gate the clock 120 from reaching the corresponding compute circuitry so that the stall logic 335 can independently stall the compute circuitry 310, 315, and 320. That is, the stall logic 335 can use one of the enable signals 350 to stall the INT4 compute circuitry 310 for one cycle (where the compute circuitry 310 is idle for that cycle) while the INT8 compute circuitry 315 and the FP compute circuitry 320 can continue to operate. In this manner, the throttling logic 330 can throttle the core 305 based on the datatypes being operated on.

The core 305 also includes debugging circuitry 325 that can be used to debug errors that occur in the core 305 and trace circuitry 340 for providing trace information when errors occur in the core 305. The debugging circuitry 325 and the trace circuitry 340 can be examples of circuitry in the core 305 that should not be stalled when the compute circuitry 310, 315, and 320 is stalled. For example, if the throttling logic 330 determines that it should stall all (or some other combination) of the INT4 compute circuitry 310, the INT8 compute circuitry 315, or the FP compute circuitry 320, the stall logic 335 may not prevent the clock 120 from reaching the debugging circuitry 325 and trace circuitry 340. Thus, these circuit block can continue to operate when some or all of the compute circuitry 310, 315, and 320 is stalled in the core 305. This may be preferred so that debugging and trace operations can be accurate and performed timely in the presence of throttling.

The debugging circuitry 325 and the trace circuitry 340 are just examples of types of circuitry in a core 305 that may be stalled. There may be other circuitry in a core 305 that a designer may not want stalled when throttling the compute circuitry 310, 315, and 320.

Moreover, for some types of architectures, it may be preferred to stall the entire core. For example, an IC that uses a very long instruction word (VLIW) instruction set architecture may gate the clock to all the compute circuitry, rather than being able to selectively gate different types of compute circuitry as shown in FIG. 3.

FIG. 3 also illustrates that the throttling logic 330 can be shared by multiple cores in the same processor 300 (or the same IC). For example, the processor 300 may include ten cores which share the same throttling logic 330. That is, the throttling logic 330 can receive data identifier signals 150 from each of the cores and then use respective stall logic to stall the cores when they exceed the maximum operation rate. Thus, the processor 300 can have multiple cores that share the same throttling logic 330. For example, the processor 300 could have twenty cores, where ten of the cores communicate with one instance of the throttling logic 330 and the other ten cores communicate with another instance of the throttling logic 330.

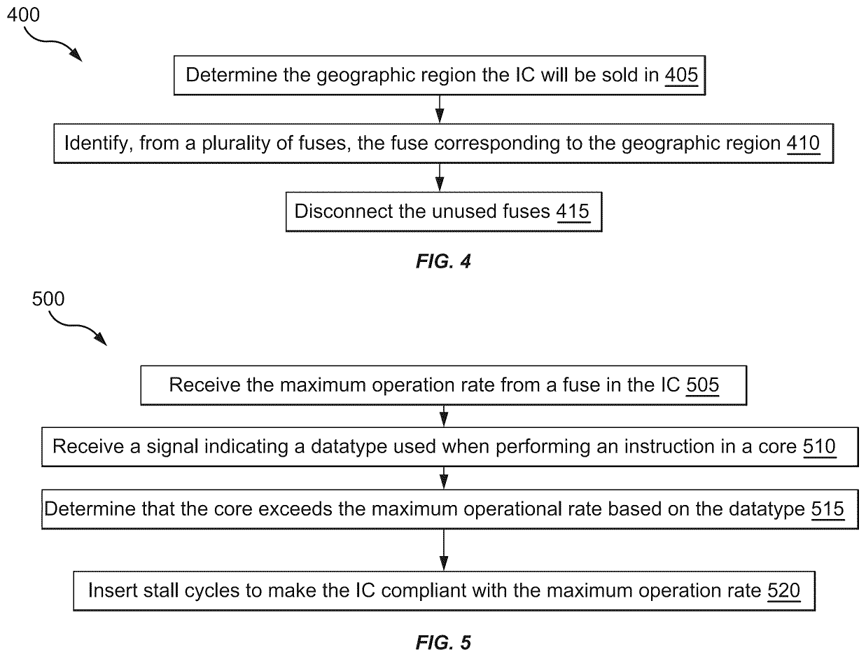

FIG. 4 is a flowchart of a method 400 for configuring an IC to satisfy export control or regulations, according to one embodiment. In one embodiment, the method 400 is performed at a manufacturer or a distributer before the IC is sold or shipped to a customer.

At block 405, the manufacturer determines the geographic region the IC will be sold in. For example, a government may have different regulations for different geographic regions, where some regions may be permitted to have faster maximum operation rates than others.

At block 410, the manufacturer identifies, from a plurality of fuses on the IC, the fuse corresponding to the geographic region. Because the fuses can be formed in the IC during fabrication, the IC can include multiple fuses to accommodate the maximum operation rates for different geographic regions. For example, the IC may have fuses that set the maximum operation rate at 50 TOPS, 100 TOPS, 150 TOPS, 200 TOPS, etc. Because it may be difficult or impossible to add new fuses in an IC after it has been fabricated, adding a plurality of different fuses when fabricating the IC can be advantageous since it may not be known where the IC will be sold, and thus, the IC has the ability to be sold in a variety of different regions.

Moreover, the IC can include fuses for different types of datatype operations, if specified by the government regulations. For example, the IC could include fuses that set the maximum operation rate of INT4 at 50 TOPS, 100 TOPS, 150 TOPS, 200 TOPS, and fuses that set the maximum operation rate of INT8 at 50 TOPS, 100 TOPS, 150 TOPS, 200 TOPS, and so forth.

At block 415, the manufacturer disconnects the unused fuses. That is, the manufacturer selects the fuses that correspond to the geographic region where the IC will be sold while the fuses corresponding to other geographic regions are disconnected or are not used. As mentioned above, the fuse selection cannot be changed once set by the manufacturer. For example, the fuses may be “blown” which is an irreversible physical process in the IC.

FIG. 5 is a flowchart of a method 500 for throttling cores in an IC to satisfy export control or regulations, according to one embodiment. In one embodiment, the method 500 is performed after the method 400, but can be used with any technique for setting a maximum operation rate in an IC.

At block 505, the throttling logic in the IC receives the maximum operation rate from a fuse in the IC. The fuse can stipulate the maximum operation rate regardless of the operation being formed by the IC (e.g., a maximum operation rate for a predefined area of silicon) or can stipulate the maximum operation rate for different datatypes. That is, the IC may have multiple fuses which stipulate the maximum operation rate when performing operations using INT4 datatypes, when performing operations using INT8 datatypes, and the like.

At block 510, the throttling logic receives a signal indicating a datatype used when performing an instruction in a core. In one embodiment, the signal is the data identifier signal 150 discussed above in FIGS. 1-3. This signal may be provided by a decoder in the core.

At block 515, the throttling logic determines that one or more cores exceed the maximum operational rate using the datatype. For example, the throttling logic may know that the core exceeds the maximum operation rate when executing an INT8 operation but not when executing a FP operation. As such, the throttling logic can stall the core when the signal received at block 510 indicates the instruction performs an INT8 operation, but not when the signal indicates the instruction performs a FP operation.

In one embodiment, the throttling logic may determine whether to stall the core based on receiving multiple signals from a decoder in the core. For example, the throttling logic may insert a stall cycle for every two INT4 operations performed by the core, or insert a stall cycle for every four INT8 operations performed by the core. Thus, the throttling logic may wait until detecting a threshold number of operations of a particular datatype before inserting one or more stalls into the core 305.

At block 520, the throttling logic inserts one or more stall cycles into the core to make the IC compliant with the maximum operation rate. These stall cycles can be inserted after the instruction has been performed, during the instruction, or before the instruction is performed.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit (IC) comprising:
a fuse that sets a maximum operational rate for the IC;
a core configured to execute an instruction; and
throttling logic comprising circuitry configured to:
receive from the core a signal indicating a datatype used when performing the instruction, and
in response to determining that the core exceeds the maximum operational rate based on the datatype, insert at least one stall cycle into the core to make the IC compliant with the maximum operational rate.

2. The IC of claim 1, wherein the core executes operations of a first datatype at a different rate than operations of a second datatype, wherein the throttling logic is configured to throttle the core by inserting stall cycles when the core executes instructions containing operations of the first datatype but not when the core executes instructions containing operations of the second datatype.

3. The IC of claim 2, wherein, when there is no throttling, a rate of executing the operations of the first datatype in the core exceeds the maximum operational rate, but a rate of executing the operations of the second datatype does not exceed the maximum operational rate.

4. The IC of claim 1, wherein the maximum operational rate is based on a government regulation and a particular geographic region.

5. The IC of claim 1, wherein the core comprises a decoder configured to transmit the signal indicating the datatype to the throttling logic.

6. The IC of claim 1, further comprising a plurality of fuses that includes the fuse, wherein the remaining fuses of the plurality of fuses store different maximum operational values, wherein the remaining fuses are not selected to control the IC.

7. The IC of claim 1, wherein the core further comprises:
first compute circuitry configured to execute operations for a first datatype; and
second compute circuitry configured to execute operations for a second datatype, wherein inserting the at least one stall cycle into the core stalls the first compute circuitry but does not stall the second compute circuitry.

8. The IC of claim 7, wherein the core further comprises:
debugging or trace circuitry, wherein inserting the at least one stall cycle into the core does not stall the debugging or trace circuitry.

9. The IC of claim 1, wherein the throttling logic comprises a counter configured to count operations performed by the core,
wherein determining, based on the datatype, that the core exceeds the maximum operational rate is also based on a value in the counter.

10. The IC of claim 1, further comprising:
stall logic configured to receive an instruction from the throttling logic to insert the at least one stall cycle into the core,
wherein the stall logic is further configured to receive a stall instruction from shared memory to stall the core, wherein the shared memory is shared by multiple cores in the IC.

11. The IC of claim 1, further comprising:
a plurality of cores that includes the core, wherein the throttling logic is configured to:
receive, from the plurality of cores, signals indicating a datatype used when performing instructions on the plurality of cores, and
insert stall cycles into the plurality of cores to make the IC compliant with the maximum operational rate.

12. A method comprising:
receiving, from a core at throttling logic, a signal indicating a datatype used when performing an instruction in the core; and
in response to determining that the core exceeds a maximum operational rate based on the datatype, inserting at least one stall cycle into the core to make the IC compliant with the maximum operation rate,
wherein the maximum operation rate is set by a fuse in an integrated circuit (IC) containing the core.

13. The method of claim 12, wherein the core executes operations of a first datatype at a different rate than operations of a second datatype, the method comprises:
inserting stall cycles when the core executes instructions containing operations of the first datatype but not when the core executes instructions containing operations of the second datatype.

14. The method of claim 13, wherein, when there is no throttling, a rate of executing the operations of the first datatype in the core exceeds the maximum operational rate, but a rate of executing the operations of the second datatype does not exceed the maximum operational rate.

15. The method of claim 12, wherein the maximum operational rate is based on a government regulation and a particular geographic region.

16. The method of claim 12, further comprising:
transmitting the signal to the throttling logic using a decoder in the core.

17. The method of claim 12, wherein the core further comprises:
first compute circuitry configured to execute operations for a first datatype; and
second compute circuitry configured to execute operations for a second datatype,
wherein inserting the at least one stall cycle into the core stalls the first compute circuitry but does not stall the second compute circuitry.

18. The method of claim 12, wherein the core further comprises:
debugging or trace circuitry, wherein inserting the at least one stall cycle into the core does not stall the debugging or trace circuitry.

19. The method of claim 12, further comprising:
counting, using a counter in the throttling logic, operations performed by the core, wherein determining, based on the datatype, that the core exceeds the maximum operational rate is also based on a value in the counter.

20. An integrated circuit (IC) comprising:
a fuse that sets a maximum operational rate for the IC, wherein the maximum operational rate is based on a government regulation and a particular geographic region;
compute circuitry configured to execute an operation; and
throttling logic comprising circuitry configured to:
receive a signal indicating a datatype used when performing the operation, and
in response to determining that the compute circuitry exceeds the maximum operational rate based on the datatype, insert at least one stall cycle into the compute circuitry to make the IC compliant with the maximum operation rate.
